(19) United States
(12) Patent Application Publication
(10) Pub. No.: US 2006/0051159 A1
(43) Pub. Date: Mar. 9, 2006

(54) Positioning device for a foldable structure

(76) Inventor: Ming-Liang Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/936,493

(22) Filed: Sep. 9, 2004

(51) Int. Cl. F16B 7/10

(52) U.S. Cl. 403/109.3

(57) ABSTRACT

A positioning device for a foldable structure includes a sliding base, a buckle having a hollow button, a trigger and a supporting rod. The sliding base has a restriction hole. The supporting rod has a locating hole corresponding to the restriction hole of the sliding base. One end of the buckle is secured to the sliding base. Another end of the buckle is secured to the trigger. The trigger comprises a stud protruding outwardly to extend into the button of the buckle. The button of the buckle is inserted into the restriction hole of the sliding base and the locating hole of the supporting rod so as to secure the sliding base to the supporting rod firmly.

### BACKGROUND OF THE INVENTION

1. Field of the Invention

This invention relates to a positioning device for a foldable structure, and more particularly to one that is applied to the frame of a foldable tent or closet.

2. Description of the Prior Art

A conventional retractable supporting rod applied to the frame of a tent or a closet is to insert an upper rod A into a lower rod B, as shown in FIGS. 8 and 9. The upper rod A has a buckle C which has a button C1 protruding from the surface of the upper rod A. The lower rod B has a sliding base D on the top end. The sliding base D comprises a locating hole D1 corresponding to the button C1 of the buckle C.

To assemble the retractable supporting rod, the upper rod A is inserted into the sliding base D secured to the top end of the lower rod B and fastened with the button C1 of the buckle C inserting into the locating hole D1 of the sliding base D.

To disassemble the retractable supporting rod, the button C1 of the buckle C is pressed to retreat the button C1 from the locating hole D1 of the sliding base D, thus the upper rod A is able to detach from the lower rod B.

However, the users' fingers may be pinched accidentally when pressing the buckle.

In view of this, the inventor has derived the preset invention.

### SUMMARY OF THE INVENTION

According to the present invention there is provided a positioning device for a foldable structure comprising a sliding base, a buckle having a hollow button, a trigger and a supporting rod. The sliding base has a restriction hole. The supporting rod has a locating hole corresponding to the restriction hole of the sliding base. One end of the buckle is secured to the sliding base. Another end of the buckle is secured to the trigger. The trigger comprises a stud protruding outwardly to extend into the button of the buckle. The button of the buckle is inserted into the restriction hole of the sliding base and the locating hole of the supporting rod so as to secure the sliding base to the supporting rod firmly.

It is the primary advantage of the present invention to provide a positioning device for a foldable structure, which is easy to operate.

It is another advantage of the present invention to provide a positioning device for a foldable structure, which is safe in use.

### BRIEF DESCRIPTION OF THE DRAWINGS

FIG. 1 is an exploded view of a first embodiment of the present invention;

FIG. 2 is a cross-sectional view showing the assembly of the first embodiment the present invention;

FIG. 3 is a cross-sectional view of the first embodiment the present invention in an operating status;

FIG. 4 is an exploded view of a second embodiment of the present invention;

FIG. 5 is a cross-sectional view of the second embodiment of the present invention;

FIG. 6 is a perspective view of a tent incorporated with the present invention;

FIG. 7 is a perspective view of a closet incorporated with the present invention;

FIG. 8 is a perspective view of a prior tent, and

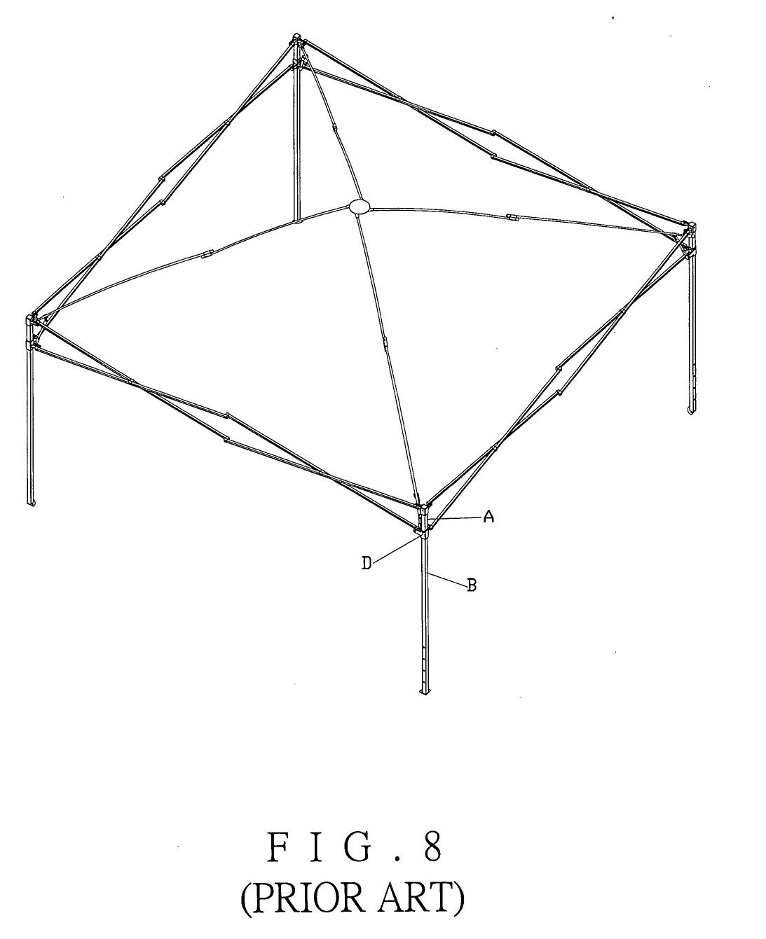

FIG. 9 is a perspective view of a prior buckle.

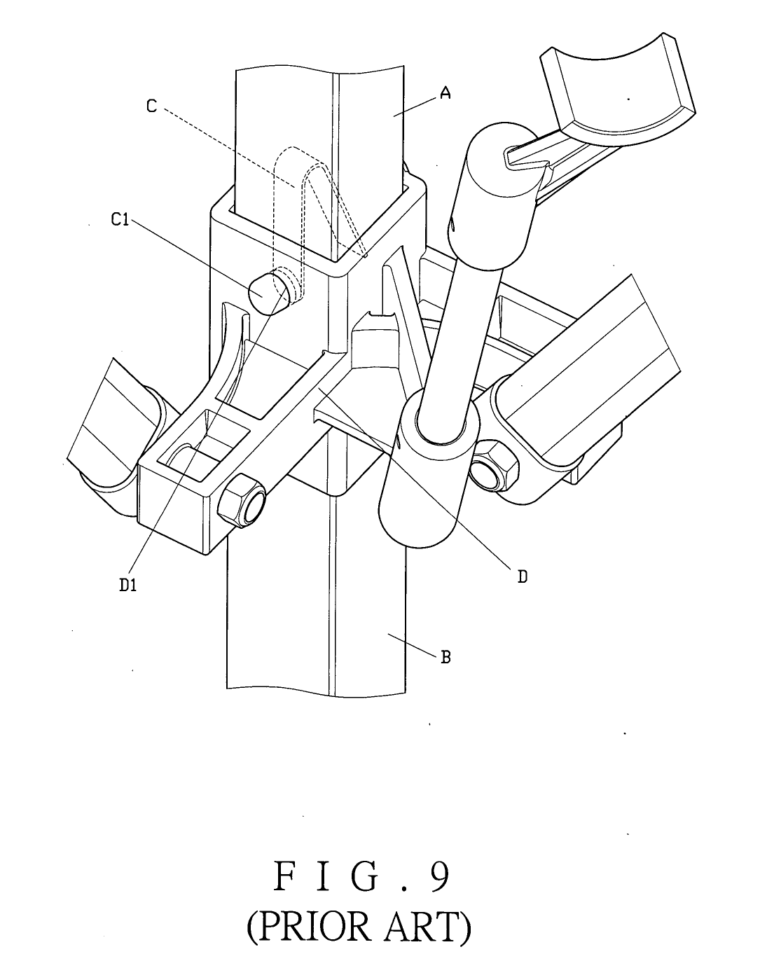

### DETAILED DESCRIPTION OF THE PREFERRED EMBODIMENT

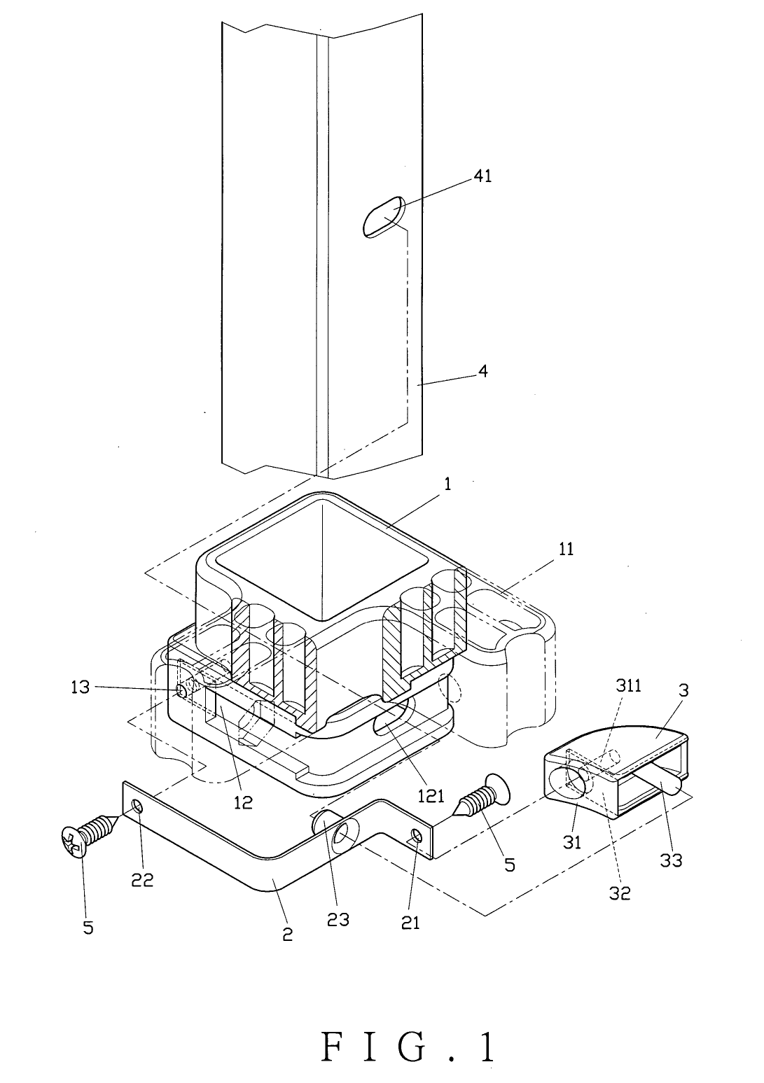

As shown in FIG. 1, the present invention comprises a sliding base 1, a buckle 2, a trigger 3, and a supporting rod 4.

The sliding base 1 has a hollow body with a connecting ridge 11 protruding from one side for insertion rods. (The direction of the connecting ridge 11 depends on the position of the rods.) A restriction trough 12 is formed at an outer circumferential portion of the sliding base 1. The sliding base 1 is provided with a restriction hole 121 in the restriction trough 12. A connecting hole 13 is formed on the sliding bade 1 relative to one end of the restriction trough 12 and interconnected with the restriction trough 12.

The buckle 2 is a piece of bending plate with a pair of locating holes 21 and 22 at respective ends. A hollow button 23 is provided on the buckle 2.

The trigger 3 is a block having an arc surface 31 at one end with a threaded hole 311 thereat. The trigger 3 is provided with a trough 32 interconnected with the threaded hole 311. The trigger 3 further comprises a stud 33 protruding outwardly.

The supporting rod 4 has a locating hole 41 corresponding to the restriction hole 121 of the sliding base 1.

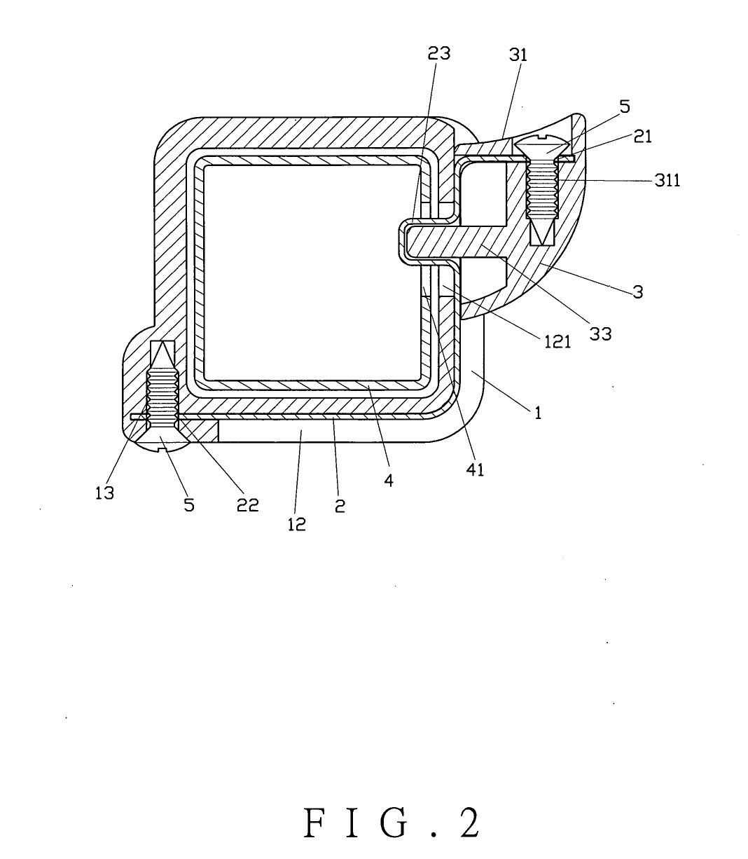

To assemble the present invention, referring to FIG. 2, one end of the buckle 2 is inserted into the trough 32 of the trigger 3 and secured with a bolt 5 inserting through the threaded hole 311 of the trigger 3 and the locating hole 21 of the buckle 2. Thus, the trigger 3 is secured to the buckle 2. The stud 33 of the trigger 3 is inserted into the button 23 of the buckle 2. The other end of the buckle 2 is inserted into the restriction trough 12 of the sliding base 1 and secured with another bolt 5 inserting through the locating hole 22 of the buckle 2 and the connecting hole 13 of the sliding base 1. Thus, the buckle 2 is secured to the sliding base 1. The supporting rod 4 is inserted into the sliding base 1. The button 23 of the buckle 2 with the stud 33 of the trigger 3 is inserted into the restriction hole 121 of the sliding base 1 and the locating hole 41 of the supporting rod 4, thus holding the sliding base 1 to the supporting rod 4 firmly.

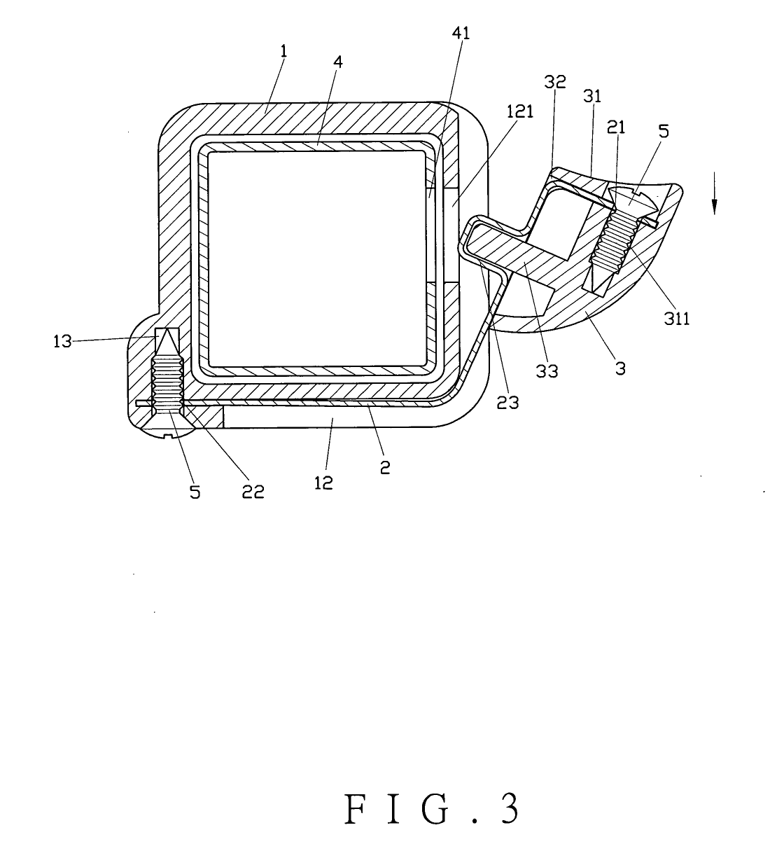

To collapse a tent or closet incorporated with the present invention, as shown in FIG. 3, the trigger 3 is pulled to release the button 23 of the buckle 2 from the restriction hole 121 of the sliding base 1 and the locating hole 41 of the supporting rod 4 so the sliding base 1 is free to slide along the supporting rod 4.

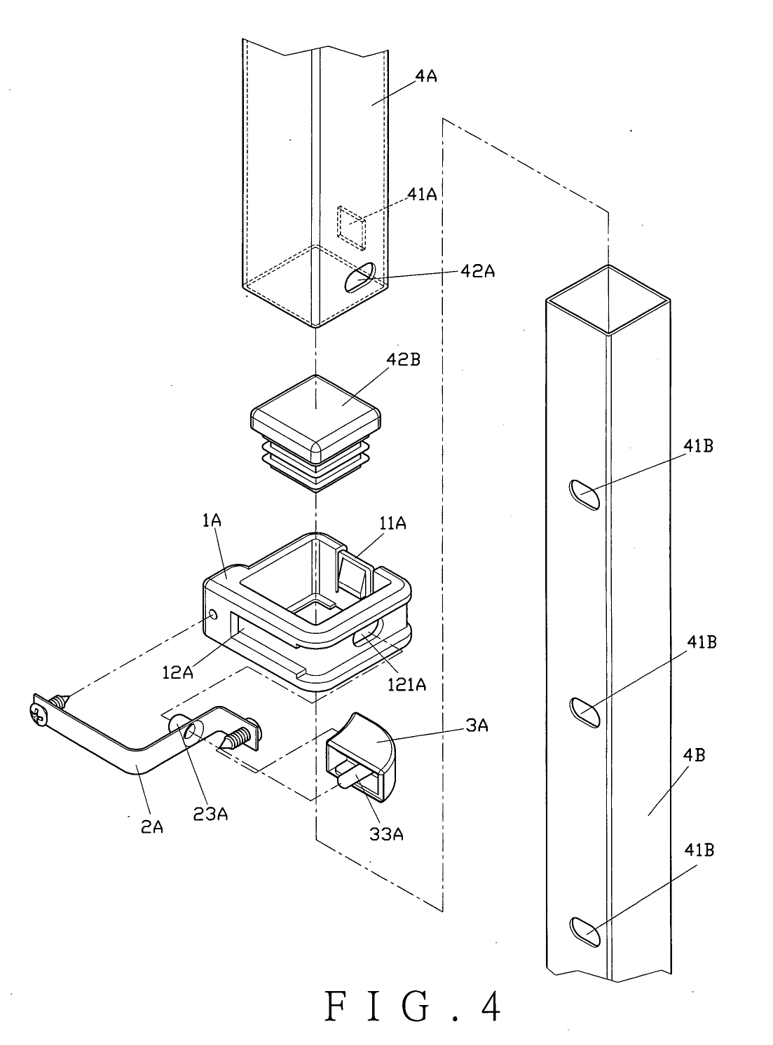

FIG. 4 shows a second embodiment of the present invention, which comprises a sliding base 1A sleeved onto an upper supporting rod 4A and a lower supporting rod 4B. The upper supporting rod 4A comprises an insertion hole 41A and a locating hole 42A. The lower supporting rod 4B has a plurality of locating holes 41B. A block 42B is provided on one end of the lower supporting rod 4B. The sliding base 1A has an elastic tenon 11A on one side. A trigger 3A is secured to a buckle 2A, and the buckle 2A is secured to the sliding base 1A. The sliding base 1A has a restriction trough 12A and a restriction hole 121A for a button 23A of the buckle 2A with a stud 33A of the trigger 3A to extend there through.

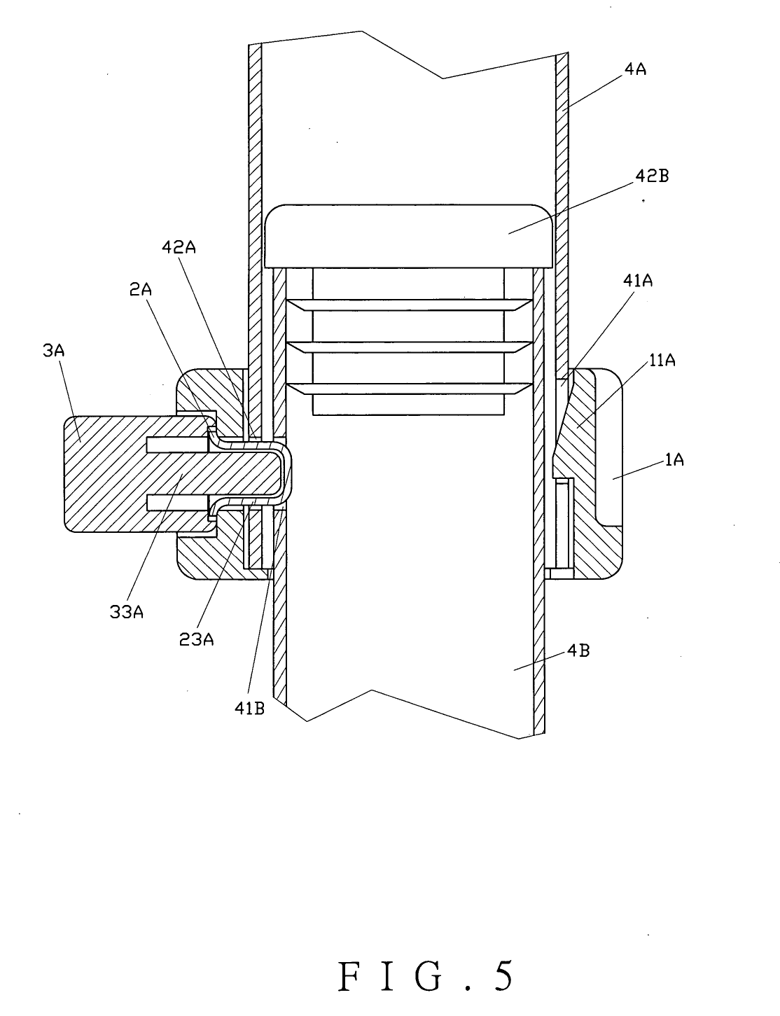

To assemble the second embodiment of the present invention, as shown in FIG. 5, the lower supporting rod 4B is inserted into the sliding base 1A with the block 42B blocking the end of the lower supporting rod 4B. Then, the upper supporting rod 4A is inserted into the sliding base 1A relative to the lower supporting rod 4B till the elastic tenon 11A engages with the insertion hole 41A and the button 23A of the buckle 2A is inserted into the locating hole 42A of the upper supporting rod 4A and one selected locating hole 41B of the lower supporting rod 4B. The upper supporting rod 4A and the lower supporting rod 4B are connected together. Due to the plural locating holes 41B of the lower supporting rod 4B, the buckle 2A may be set in various positions. And this design eliminates the possibility of pinching fingers.

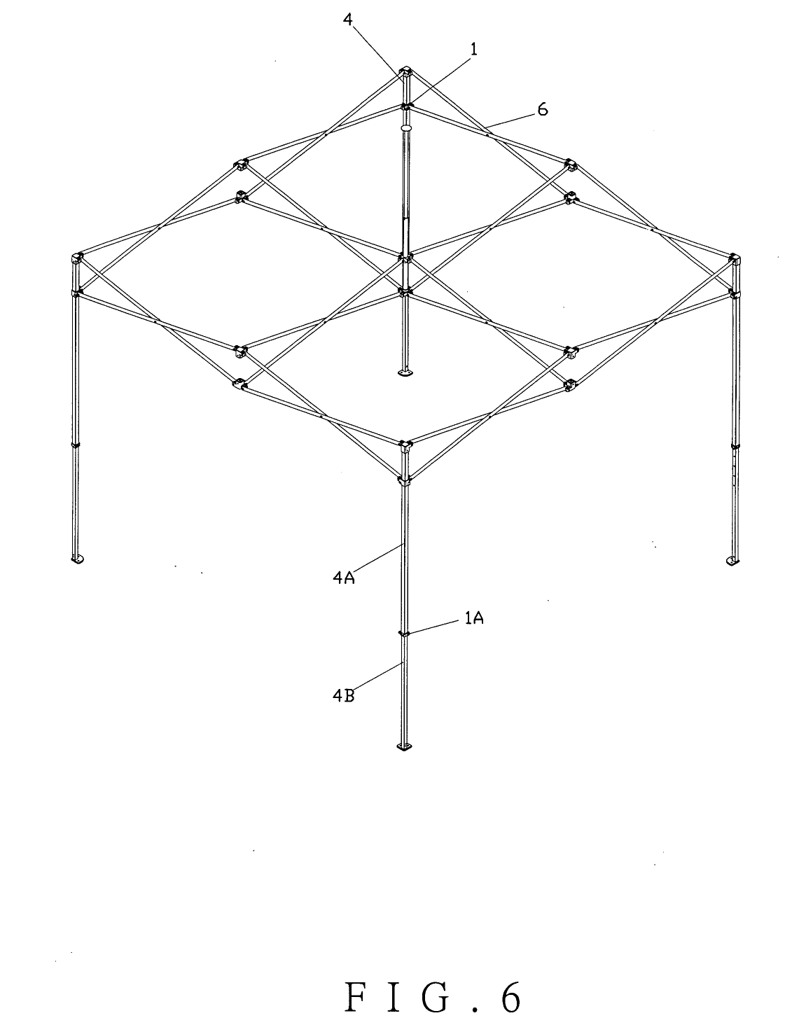

Furthermore, this design is applicable to use in many frames, such as the frame of a tent, as shown in FIG. 6, the trigger (not shown in this drawing) on the sliding base 1, 1A is pulled to expand or collapse a rod 6 or the supporting rod 4 (or the upper supporting rod 4A and the lower supporting rod 4B).

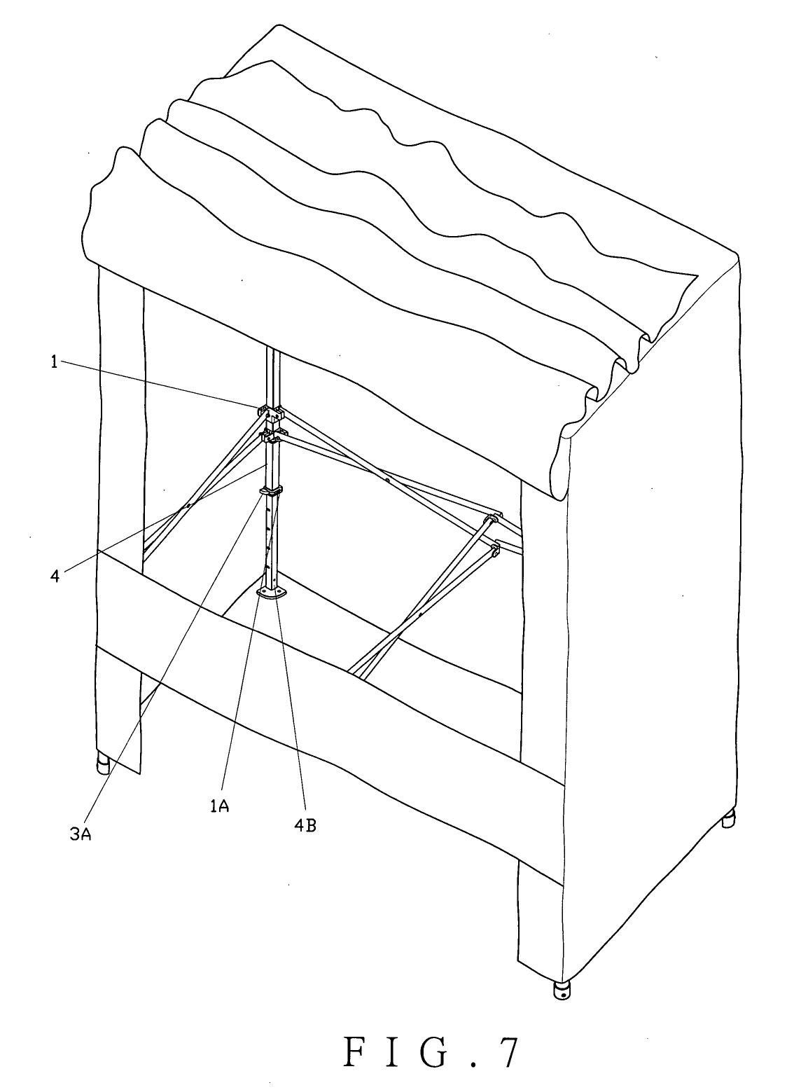

As shown in FIG. 7, the present invention is applied to the frame of a closet. The trigger 3A is pulled to allow the sliding base 1A to slide along the supporting rod 4, (or along the upper supporting rod 4A and the lower supporting rod 4B) to collapse or to expand the frame of the closet.

What is claimed is:

1. A positioning device for a foldable structure comprising a sliding base, a buckle, a trigger and a supporting rod,
said sliding base comprising a restriction hole therein, said supporting rod being inserted into said sliding base and comprising a locating hole corresponding to said restriction hole of said sliding base, said buckle comprising a hollow button, said buckle having one end secured to said sliding base and another end secured to said trigger, said trigger comprising a stud to extend into said button of said buckle;
thereby said button of said buckle inserting into said restriction hole of said sliding base and said locating hole of said supporting rod to secure said sliding base at place, said button of said buckle with said stud of said trigger being retreated from said locating hole of said supporting rod when said trigger is pulled.

2. The positioning device for a foldable structure, as recited in claim 1, wherein said sliding base comprises an elastic tenon and said supporting rod comprises an insertion hole for said elastic tenon to seat therein.

3. The positioning device for a foldable structure, as recited in claim 1, wherein said sliding base comprises a restriction trough at an outer circumferential portion to secure one end of said buckle.

4. The positioning device for a foldable structure, as recited in claim 1, wherein said trigger comprises a trough to secure the other end of said buckle.
